(19) United States
(12) Patent Application Publication
(10) Pub. No.: US 2009/0092537 A1
(43) Pub. Date: Apr. 9, 2009

(54) PROCESS FOR OBTAINING PELLETIZED GRAPHITE

(75) Inventor: Helvecio A. Vespucio, Agua Limpa (BR)

Correspondence Address: FULBRIGHT & JAWORSKI, LLP, 1301 MCKINNEY, SUITE 5100, HOUSTON, TX, 77010-3095, US

(73) Assignee: Pinheiro Neto Advogados, Sao Paula (BR)

(21) Appl. No.: 12/243,591

(22) Filed: Oct. 1, 2008

(30) Foreign Application Priority Data
Oct. 3, 2007 (BR) PI 0706103-0

(51) Int. Cl. C01B 31/04

(52) U.S. Cl. 423/448

(57) ABSTRACT

A process for obtaining pelletized graphite from graphite is disclosed. The process obtains pelletized graphite or natural graphite in any form, including pellets, flakes and grains from graphite, dry based graphite or wet based graphite.

### CROSS-REFERENCE TO RELATED APPLICATIONS

This Application claims priority under 35 U.S.C. § 119 to Brazilian Patent Application Number PI0706103-0 filed on Oct. 3, 2007, which is incorporated by reference herein in its entirety.

### TECHNICAL FIELD

The present invention relates to a process for obtaining pelletized graphite from graphite. More specifically, the present invention relates to obtaining pelletized graphite or natural graphite in any form, including but not limited to pellets, flakes or grains from dry graphite-based material or wet graphite-based material.

### BACKGROUND OF THE INVENTION

The process for obtaining pellitized graphite from graphite, dry graphite-based material or wet graphite-based material comprises adding graphite and a binder in a reactor, homogenizing the mixture, adding water, pelletizing product, finishing and drying the product. Also, this process may include the steps of grading the product and packaging the product according to size.

The binder is used to prevent losing thin graphite with low ash content before reaching the metal bath. Adding a binder gives the desired product in a higher yield. The binder is usually added before the pelletizing stage. This is when the cohesion forces, such as particle cohesion, valence forces, recrystallization or Van der Waals forces between particles are considered weak. A wide variety of binders, solid or liquid can be used. Binders that can be used include, but are not limited to carboxy-methyl-cellulose, dextrin, asphalt, starch, cassaya starch, bentonite, bitumen, lime, cement, molasses, metassilicato, sodium silicate, different resins and/or polymers. The binder should be low cost, non-toxic and have a long life, but should not be hygroscopic. Additionally, the binder should have low levels of sulfur and nitrogen while not raising the volatile content in the pelletized graphite above certain values.

The pelletized graphite obtained by the process according to this invention can be dried in any type of dryer, such as, rotary steam dryers, common rotary dryers, wake dryers, fluid bed dryers and/or any similar dryer.

### BRIEF SUMMARY OF THE INVENTION

The present invention provides a process for obtaining pelletized graphite comprising adding a binder and a graphite starting material in a reactor, homogenizing a graphite/binder mixture, adding water to the graphite/binder mixture, palletizing a graphite product, finishing the graphite product and drying the graphite product. In some embodiments of the present invention, the process for obtaining palletized graphite comprises grading the graphite product and packaging the graphite product.

In specific embodiments of the present invention, the graphite starting material is selected from the group consisting of a wet graphite-based material and a dry graphite-based material. In some embodiments, the graphite starting material has a carbon content between 30% and 99% by weight. In other embodiments, the graphite starting material has a carbon content between 50% and 90% by weight. In additional embodiments, the graphite starting material has a moisture content of 40% to 99.99% by weight. In other embodiments, the graphite starting material has a moisture content of 60% and 90% by weight. In particular embodiments, the graphite starting material has a particle size of 50 mesh size or less. In some embodiments, the graphite starting material has a particle size of 40 mesh size or less.

In some embodiments of the present invention, the binder has a moisture content between 0.1% and 60% by weight. In some additional embodiments, the binder has a moisture content between 1% and 40% by weight. In further embodiments, the binder has a moisture content between 10% and 30% by weight. In specific embodiments, the binder is a cellulose base binder.

In some embodiments of the present invention, the graphite product is palletized graphite. In specific embodiments of the present invention, the graphite product is in a form comprising pellets, flakes and grains.

The foregoing has outlined rather broadly the features and technical advantages of the present invention in order that the detailed description of the invention that follows may be better understood. Additional features and advantages of the invention will be described hereinafter which from the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention set forth in the appended claims. The novel features which are believed to be characteristic of the invention, both as its organization and method of operation, together with further objects and advantages with the accompanying figures. It is to be expressly understood, however, that each of the figures is provided for the purpose of illustration and description only and is not intended as a definition of the limits of the present invention.

### DETAILED DESCRIPTION OF THE INVENTION

The process for obtaining pelletized graphite comprises the steps of adding a binder and graphite in a reactor, homogenizing the binder/graphite mixture, adding water to the graphite/binder mixture, pelletizing the product, finishing the product and drying the product. Preferably, the process includes the steps of grading the pelletized graphite and packaging the pelletized graphite. Additionally, in the step of adding the binder and graphite in a reactor, the graphite used is either a dry graphite-based material or a wet graphite-based material.

The graphite used in the above process may have a carbon content of 30% to 99.99%. Preferably, the carbon content is between 50% and 99.99%. Also, the graphite used as a starting material may have a moisture content between 60% and 90% of the total weight of the graphite. The preferred moisture content is between 60% and 90% of the total weight of the graphite. The mesh size of the graphite starting material should be less than 50 mesh size according to the ASTM (American Society for Testing and Materials). It is preferred that the mesh size is less than 40.

A wide variety of binders, solid or liquid can be used. Binders that can be used include, but are not limited to carboxy-methyl-cellulose, dextrin, asphalt, starch, cassaya starch, bentonite, bitumen, lime, cement, molasses, metassilicato, sodium silicate, different resins and/or polymers. The binder should be low cost, non-toxic, have a long life, but should not be hygroscopic. Additionally, the binder should have low levels of sulfur and nitrogen while not raising the volatile content in the pelletized graphite above certain values. The preferred binder is a cellulose based binder. The binder used in the present invention should have a moisture content in a range between 0.1% to 60% by weight. Additionally, the moisture content of the binder may be in the range of 1% to 40% by weight and it is preferred that the moisture content of the binder is between 10% and 30% by weight.

The process of the present invention yields palletized graphite. The palletized graphite is obtained in the form of pellets, flakes or grains. The following examples are included to demonstrate preferred embodiments of the invention. It should be appreciated by those of skill in the art that the techniques disclosed in the examples which follow represent techniques discovered by the inventor to function well in the practice of the invention, and thus can be considered preferred modes for its practice. However, those of skill in the art should, in light of the present disclosure, appreciate that many changes can be made in the specific embodiments which are disclosed and still obtain a like or similar result without departing from the spirit and scope of the invention.

For example, the quantitative description for obtaining pelletized graphite from dry graphite based material uses 1.0 ton of graphite, 5 kg of binder, 150 kg of water to yield 1.155 kg of pelletized graphite (87% dried). The process for obtaining pelletized graphite from wet graphite based material uses 1.0 ton of wet graphite (90% dried), 5 kg of binder and 50 kg of water to yield 1.155 kg of pelletized graphite (87% dried). In another example, uses a granular mixer and dry graphite based material to obtain pelletized graphite. In this example, 1.0 ton of dried graphite, 5 kg of binder and 150 kg of water are used. Using a wet graphite based material and a granular mixture, 1.0 ton of wet graphite (90% dried), 5 kg of binder and 50 kg of water yields 1.155 kg of pelletized graphite (87% dried).

Additional examples, include using a dry graphite based material followed by subsequent drying. This example uses 1.0 ton of dried graphite, 5 kg of binder and 150 kg of water and the line speed and temperature of the dryer were adjusted to achieve a humidity of 0.3%. In another example, a granular mixer and wet graphite based material was used. This example uses 1.0 ton of wet graphite (90% dried), 5 kg of binder and 50 kg of water and the line speed and temperature of the dryer were adjusted to achieve a humidity of 0.2%. Yet another example that uses dry graphite based material, a drying step and a subsequent grading step. This example uses 1.0 ton of dried graphite, 5 kg of binder, 150 kg of water. The line speed and temperature of the dryer were adjusted to achieve a humidity of 0.3%. After the drying step, sieves boxes were used to achieve the specified size distribution of 35 mesh (ASTM) wherein 95% of the desired product was retained.

In other examples, pelletized graphite is produced using a wet graphite based material, a granular mixer, a drying step followed by grading. This example uses 1.0 ton of wet graphite (90% dried), 5 kg of binder and 50 kg of water. The line speed and temperature of the dryer is adjusted to achieve a final humidity of 0.2% and sieves boxes are used to achieve the specified size distribution of 35 mesh (ASTM) wherein 95% of the desired product was retained. In the example where dry graphite based material and a granular mixer were used to produce pelletized graphite by a process that involved drying, grading and subsequent packaging of the palletized graphite, 1.0 ton of graphite, 5 kg of binder and 150 kg of water were used. The line speed and temperature of the dryer were adjusted to achieve a humidity of 0.3%, sieves boxes were used to achieve the specified size distribution of 35 mesh (ASTM) wherein 95% of the desired product was retained, and the final palletized graphite was packaged into bags of 10 kg, 20 kg, or 25 kg net weight of product. In yet another example, wherein wet graphite based material and a granular mixer were used to produce pelletized graphite by a process that involved drying, grading and subsequent packaging of the palletized graphite, 1.0 ton of wet graphite (90% dried), 5 kg of binder and 50 kg of water were used. The line speed and temperature of the dryer were adjusted to achieve a humidity of 0.2%, sieves boxes were used to achieve the specified size distribution of 35 mesh (ASTM) wherein 95% of the desired product was retained, and the final palletized graphite was packaged into bags containing 900 kg or 1000 kg net weight of product.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process for producing a finished graphite product comprising:
adding a binder and a graphite starting material in a reactor
homogenizing a graphitelbinder mixture
adding water to the graphitelbinder mixture
palletizing a graphite product
finishing the graphite product; and,
drying the graphite product.

2. The process of claim 1, further comprising;
grading the graphite product; and,
packaging the graphite product.

3. The process of claim 1, wherein
the graphite starting material is selected from the group consisting of a wet graphite based material and a dry graphite based material.

4. The process of claim 3, wherein the graphite starting material has a carbon content between 30% and 99% by weight.

5. The process of claim 3, wherein the graphite starting material has a carbon content between 50% and 90% by weight.

6. The process of claim 1, wherein the graphite starting material has a moisture content of 40% to 99.99% by weight.

7. The process of claim 1, wherein the graphite starting material has a moisture content of 60% and 90% by weight.

8. The process of claim 1, wherein the graphite starting material has a particle size of 50 mesh size or less.

9. The process of claim 1, wherein the graphite starting material has a particle size of 40 mesh size or less.

10. The process of claim 1, wherein the binder has a moisture content between 0.1% and 60% by weight.

11. The process of claim 1, wherein the binder has a moisture content between 1% and 40% by weight.

12. The process of claim 1, wherein the binder has a moisture content between 10% and 30% by weight.

13. The process of claim 1, wherein the binder is a cellulose base binder.

14. The process of claim 1, wherein the graphite product is pelletized graphite.

15. The process of claim 1, wherein the graphite product is in a form comprising pellets, flakes and grains.
